(19) United States
(12) Patent Application Publication
(10) Pub. No.: US 2011/0022783 A1
(43) Pub. Date: Jan. 27, 2011

(54) FLASH STORAGE WITH INCREASED THROUGHPUT

(75) Inventor: Mark MOSHAYEDI, Newport Coast, CA (US)

Correspondence Address: MCDERMOTT WILL & EMERY LLP, 18191 VON KARMAN AVE., SUITE 500, IRVINE, CA, 92612-7108, US

(73) Assignee: STEC, INC., Santa Ana, CA (US)

(21) Appl. No.: 12/509,405

(22) Filed: Jul. 24, 2009

(51) Int. Cl. G06F 12/00; G06F 13/14; G06F 12/02

(52) U.S. Cl. 711/103; 710/305; 711/E12.001; 711/E12.008

(57) ABSTRACT

A flash storage system includes a flash storage controller coupled to storage modules of a flash storage array via universal serial buses. Each storage module includes at least one flash memory device. The flash storage controller receives a programming command of a communication protocol and generates universal serial bus commands based on the programming command. The flash storage controller issues the universal serial bus commands to storage modules in the flash storage array via the universal serial buses. The storage modules process the universal serial bus commands to access data in the flash storage devices of the storage modules.

### BACKGROUND

1. Field of Invention

The present invention generally relates to flash storage devices. More particularly, the present invention relates to systems and methods of accessing data in an array of flash storage devices.

2. Description of Related Art

A flash storage system typically includes a flash controller and an array of flash storage devices, such as flash storage chips. The flash controller accesses data in the flash storage devices via a data bus. In some flash storage systems, the flash controller accesses data in the flash storage devices in parallel via multiple data buses to increase the throughput of the flash storage system.

The storage capacity of the flash storage system depends upon the number and data size of the flash storage devices in the flash storage system. The throughput of the flash storage system depends upon the number of flash storage device that can be accessed in parallel. The number of flash storage devices and the number of data buses are sometimes increased in an attempt to increase the storage capacity and throughput of the flash storage system.

As the number of flash storage devices or data buses in the flash storage system increases, however, the flash controller becomes a bottleneck in the flash storage system. Consequently, a tradeoff is often made between the throughput and the storage capacity of the flash storage system. In particular, the flash controller is often implemented as an integrated circuit chip, and the number of data buses in the flash storage system is limited by the number of pins in the integrated circuit chip.

In light of the above, a need exists for increasing the storage capacity of a flash storage system. A further need exists for increasing the throughput of a flash storage system.

### SUMMARY

In various embodiments, a flash storage system includes a flash storage controller coupled to storage modules of a flash storage array via universal serial buses. Each storage module includes at least one flash memory device. The flash storage controller receives a programming command of a communication protocol and generates universal serial bus commands based on the programming command. The flash storage controller issues the universal serial bus commands to storage modules in the flash storage array via the universal serial buses. The storage modules process the universal serial bus commands to access data in the flash storage devices of the storage modules. Processing the universal serial bus commands in the storage modules instead of the flash storage controller increases the throughput of the flash storage system. Moreover, the multiple universal serial buses allow an increased storage capacity of the flash storage system.

A system, in accordance with one embodiment, includes a flash storage controller, universal serial buses, and storage modules. Each storage module is coupled to one of the universal serial buses and includes one or more flash storage devices. The flash storage controller is coupled to the universal serial buses and is configured to receive a programming command of a communication protocol. The flash storage controller is further configured to generate at least one universal serial bus command based on the programming command, and issue at least one universal serial bus command to at least one of the storage modules via at least one of the universal serial busses for accessing data in at least one flash storage device of at least one of the storage modules.

A method, in accordance with one embodiment, includes receiving a programming command of a communication protocol and generating at least one universal serial bus command based on the programming command. Additionally, the method includes issuing the at least one universal serial bus command to at least one storage module via at least one universal serial bus for accessing data in at least one flash storage device of at least one storage module.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 is a block diagram of a flash storage system, in accordance with an embodiment of the present invention;

FIG. 2 is a block diagram of storage processor, in accordance with an embodiment of the present invention;

FIG. 3 is a block diagram of a storage module, in accordance with an embodiment of the present invention;

FIG. 4 is a flow chart of a method of accessing data in a flash storage array, in accordance with an embodiment of the present invention; and

FIG. 5 is a flow chart of a method of accessing data in the flash storage array, in accordance with another embodiment of the present invention.

### DESCRIPTION

In various embodiments, a flash storage system receives a programming command of a communication protocol and generates universal serial bus commands based on the programming command. The flash storage controller issues the universal serial bus commands to storage modules of a flash storage array via universal serial buses. The storage modules process the universal serial bus commands to access data in flash storage devices of the storage modules.

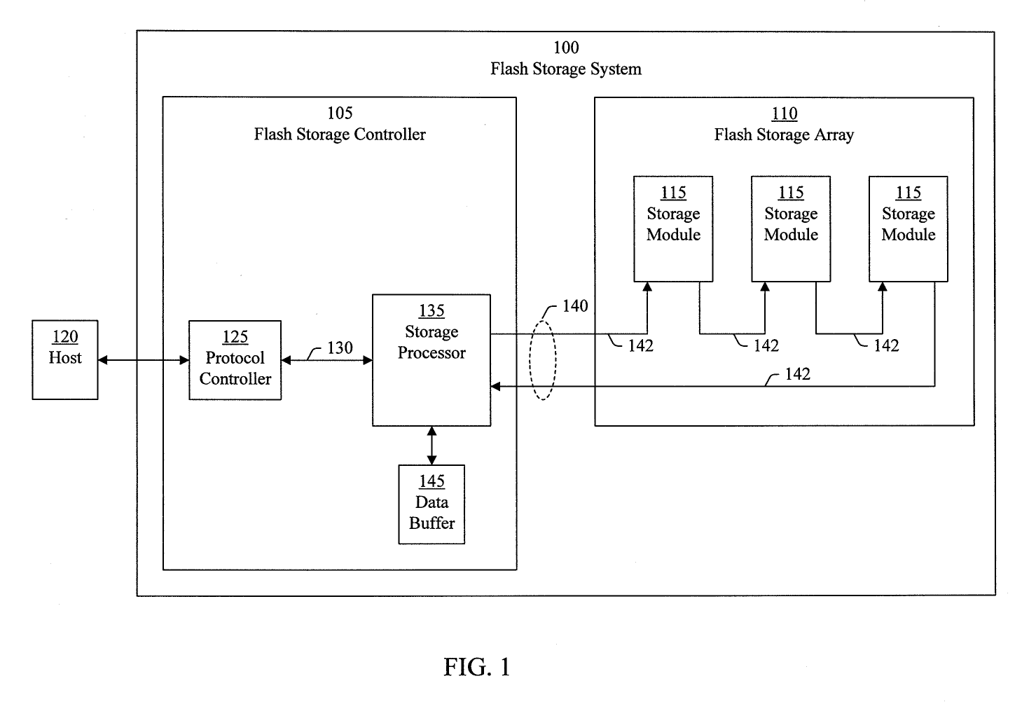

FIG. 1 illustrates a flash storage system 100, in accordance with an embodiment of the present invention. The flash storage system 100 includes a flash storage controller 105 and a flash storage array 110. The flash storage controller 105 is coupled in communication with a host 120. The host 120 can be a computing system, a cellular phone, a personal digital assistant, a portable computer, or any other electronic device. Additionally, the flash storage controller 105 is coupled in communication with the flash storage array 110 via universal serial buses 140a and 140b. Each universal serial bus (USB) 140a and 140b can be a differential bus. The flash storage array 110 includes storage modules 115, each of which is coupled in communication with one of the universal serial busses 140a and 140b. Although two universal serial buses 140a and 140b are shown in FIG. 1, the flash storage system 100 can have more or fewer universal serials busses 140 coupled to the flash storage controller 105 and the storage modules 115.

The flash storage controller 105 receives a programming command of a communication protocol and generates one or more universal serial bus (USB) commands based on the programming command. The communication protocol can be any block-based storage area network protocol, such as the Integrated Drive Electronics protocol, the Internet Small Computer System Interface protocol, the Serial Advanced Technology Attachment protocol, the Fibre Channel protocol, the Serial Attached Small Computer System Interface protocol, the HyperTransport protocol, or the like.

The flash storage controller 105 issues the universal serial bus commands to the flash storage array 110 via one or more of the universal serial busses 140a and 140b for accessing data in one or more of the storage modules 115. Each storage module 115 that receives a USB command from the flash storage controller 105 via one of the universal serial busses 140a or 140b processes the USB command to access data in the storage module 115. Additionally, the storage module 115 can provide the data accessed in the storage module 115 to the flash storage controller 105. In turn, the flash storage controller 105 can provide the data received from the storage module 115 to the host 120.

In one embodiment, the flash storage controller 105 includes a protocol controller 125, a computer bus 130, a storage processor 135, and a data buffer 145. The protocol controller 125 is coupled to the host 120. Additionally, the protocol controller 125 is coupled to the storage processor 135 via the computer bus 130. The computer bus 130 can be a Peripheral Component Interconnect (PCI) bus, or any other computer bus for communicating data between the protocol controller 125 and the storage processor 135. The storage processor 135 is coupled in communication with the data buffer 145 and each of the universal serial buses 140a and 140b. The data buffer 145 can be a random access memory, such as a cache memory.

The protocol controller 125 receives a programming command of a communication protocol from the host 120 and generates programming instructions for the storage processor 135 based on the programming command. The storage processor 135 processes the programming instructions to access data in one or more of the storage modules 115. The programming instructions may include programming routines or programming procedures for accessing data in the storage modules 115. For example, the programming instructions may include a programming routine for reading data from one or more storage modules 115, or for writing data into one or more of the storage modules 115. As another example, the programming instructions may include a programming procedure for modifying data in one or more of the storage modules 115.

In one embodiment, the storage processor 135 receives programming instructions from the protocol controller 125 for writing data into the flash storage array 110. The storage processor 135 processes the programming instructions to generate one or more USB commands for writing the data into one or more of the storage modules 115. The storage processor 135 issues each USB command to a storage module 115 via one or more of the universal serial buses 140a or 140b. In turn, each storage module 115 that receives a USB command via the universal serial bus 140a or 140b processes the USB command to store the data.

The storage processor 135 may receive programming instructions from the protocol controller 125 for reading data from the flash storage array 110. The storage processor 135 processes the programming instructions to generate one or more USB commands for reading the data from one or more of the storage modules 115. The storage processor 135 issues each USB command to a storage module 115 via one or more of the universal serial buses 140a or 140b. In turn, each storage module 115 that receives a USB command via the universal serial bus 140a or 140b processes the USB command to access the data, or a portion thereof, in the storage module 115. Additionally, the storage module 115 provides the data, or the portion of the data, to the storage processor 135 via one of the universal serial busses 140a or 140b. The storage processor 135 writes the data, or portions thereof, into the data buffer 145, and the data buffer 145 stores the data. Furthermore, the storage processor 135 provides the data to the protocol controller 125 via the computer bus 130, and the protocol controller 125 provides the data to the host 120.

The storage processor 135 may receive programming instructions from the protocol controller 125 for modifying data of a data unit in the flash storage array 110. For example, the data unit may be a memory block and the data to be modified may be a data byte or a data word in the memory block. The storage processor 135 writes data to be modified into the data buffer 145. Additionally, the storage processor 135 processes the programming instructions to generate one or more USB commands for reading any remaining data of the data unit from one or more of the storage modules 115. The storage processor 135 issues each USB command to a storage module 115 via one or more of the universal serial buses 140a or 140b. In turn, each storage module 115 that receives a USB command via the universal serial bus 140a or 140b processes the USB command and provides the remaining data to the storage processor 135 via one of the universal serial busses 140a or 140b. The storage processor 135 writes the data received from the storage module 115 into the data buffer 145, and the data buffer 145 stores the data. Thus, the data buffer 145 stores the data unit including the modified data.

The storage processor 135 further processes the programming instructions to generate one or more USB commands for writing the data of the data unit stored in the data buffer 145 into one or more of the storage modules 115. The storage processor 135 issues each USB command to one or more of the storage modules 115 via one or more of the universal serial buses 140a or 140b. In turn, each storage module 115 that receives a USB command via the universal serial bus 140a or 140b processes the USB command to store the data. In this way, the data unit with the modified data replaces the previous data unit in the flash storage array 110.

In one embodiment, the storage processor 135 can simultaneously store the modified data into the data buffer 145 and issue the USB commands to read the remaining data of the data unit from the flash storage array 110. Thus, the storage processor 135 can issue the USB commands and store the modified data into the data buffer 145 in parallel. Moreover, the storage processor 135 can simultaneously write the modified data into the data buffer 145 and write the data read from the flash storage array 110 into the data buffer 145. Thus, the storage processor 135 can write the modified data and the data read from the flash storage array 110 into the data buffer 145 in parallel.

The USB commands for writing the data of the data unit stored in the data buffer 145 into one or more of the storage modules 115 may include one or more USB commands for erasing one or more storage blocks in one or more storage modules 115 in which the data is to be written. The storage processor 135 issues a USB command for erasing a storage block to a storage module 115 via one of the universal serial busses 140a or 140b before issuing a USB command for writing data of the data unit stored in the data buffer 145 into the storage module 115.

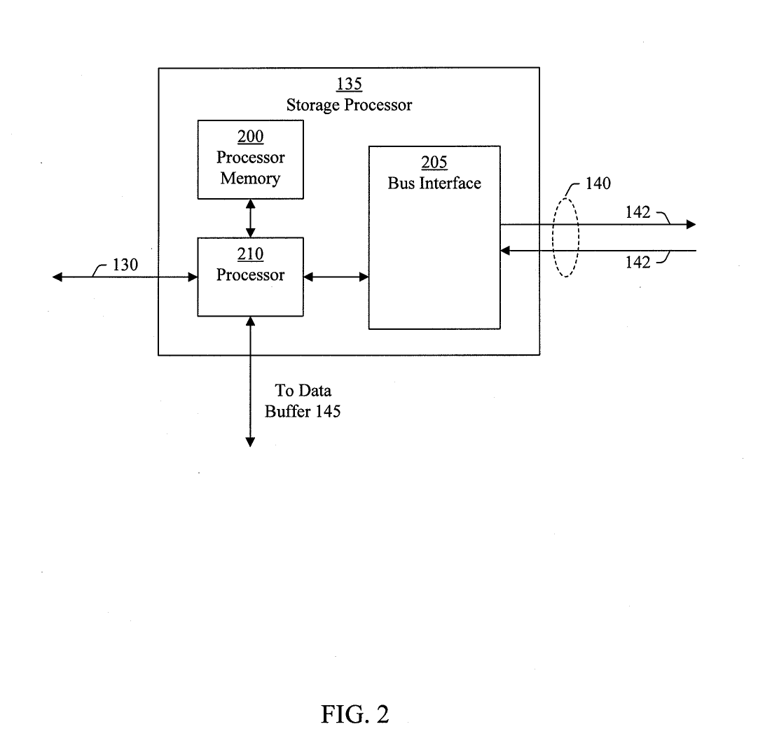

FIG. 2 is a block diagram of the storage processor 135, in accordance with an embodiment of the present invention. The storage processor 135 includes a processor 210, a processor memory 210, and an interconnect fabric 205. The processor 210 is coupled in communication with the protocol controller 125 (FIG. 1) via the computer bus 130. Additionally, the processor 210 is coupled to the data buffer 145 (FIG. 1), the processor memory 200, and the interconnect fabric 205. The processor 210 can be a microprocessor, an embedded controller, a logic circuit, or the like.

The processor memory 200 stores data for the processor 210. For example, the processor memory 200 can store software or firmware for controlling operation of the processor 210. The processor memory 200 can be a static memory, a dynamic memory, or any random access memory.

The processor 210 receives programming instructions from the protocol controller 125 (FIG. 1) and processes the programming instructions to generate USB commands. Additionally, the processor 210 can store the programming instructions or other data generated during processing of the programming instructions into the processor memory 200. In one embodiment, the processor 210 generates an integrity value for data contained in the programming instructions. The integrity value can be an error correction code or a checksum for the data. Further, the processor can write the data of the programming instructions into the data buffer 145 as well as data read from the flash storage array 110 (FIG. 1).

The interconnect fabric 205 facilitates communication between the processor 210 and the universal serial buses 140a or 140b. The processor 210 issues a USB command to the interconnect fabric 205 and the interconnect fabric 205 routes the USB command to the appropriate USB bus 140a or 140b based on the USB command. Additionally, the interconnect fabric 205 can receive data via the universal serial bus 140a or 140b in response to the USB command and route the data to the processor 210. The interconnect fabric 205 can be a logic circuit, a programmable logic array, a programmable logic device, a programmable array logic, an application specific integrated circuit, a gate array, a custom integrated circuit, or the like.

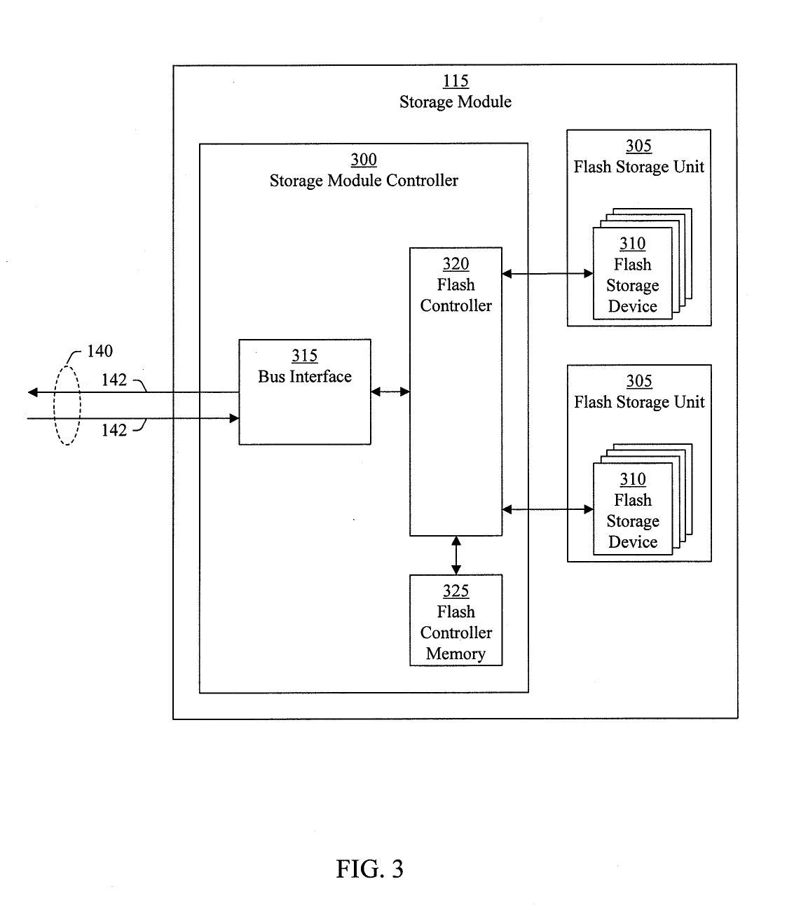

FIG. 3 illustrates a storage module 115, in accordance with an embodiment of the present invention. The storage module 115 includes a universal serial bus controller (USB controller) 300 and one or more flash storage units 305. The USB controller 300 is coupled in communication with one of the universal serial busses 140a or 140b. Additionally, the USB controller 300 is coupled in communication with each of the flash storage units 305 of the storage module 115. Although two flash storage units 305 are shown in FIG. 3, the storage module 115 can have more or fewer flash storage units 305.

USB controller 300 receives USB commands from the universal serial bus 140a or 140b and processes the USB commands to access data in the flash storage units 305. For example, the USB controller 300 can process a USB command to write data into a flash storage unit 305 or read data from a flash storage unit 305. As another example, the USB controller 300 can process a USB command to erase a storage block in a flash storage unit 305. The USB controller 300 can be any controller that is capable of processing USB commands according to a USB protocol.

In one embodiment, each flash storage unit 305 includes one or more flash storage devices 310, and the USB controller 300 includes a USB interface 315, a flash controller 320, and a flash memory controller 325. The USB interface 315 is coupled in communication with one of the universal serial busses 140a or 140b and the flash controller 320. The flash controller 320 is coupled in communication with the flash controller memory 325 and the flash storage devices 310 of the flash storage units 305.

The USB interface 315 facilitates communication between the universal serial bus 140a or 140b coupled to the flash storage module 115 and the flash controller 320. The flash controller memory 325 stores data for the flash controller 320. The flash controller 320 accesses data in the flash storage devices 310 based on USB commands received by the USB interface 315. The flash controller 320 can write data into the flash storage devices 310, read data from the flash storage devices 310, or erase storage blocks in the flash storage devices 310. Additionally, the flash controller 320 can provide data accessed in a flash storage device 310 to the USB interface 315, and the USB interface 315 can provide the data to the storage processor 135 via the universal serial bus 140a or 140b coupled to the storage module 115.

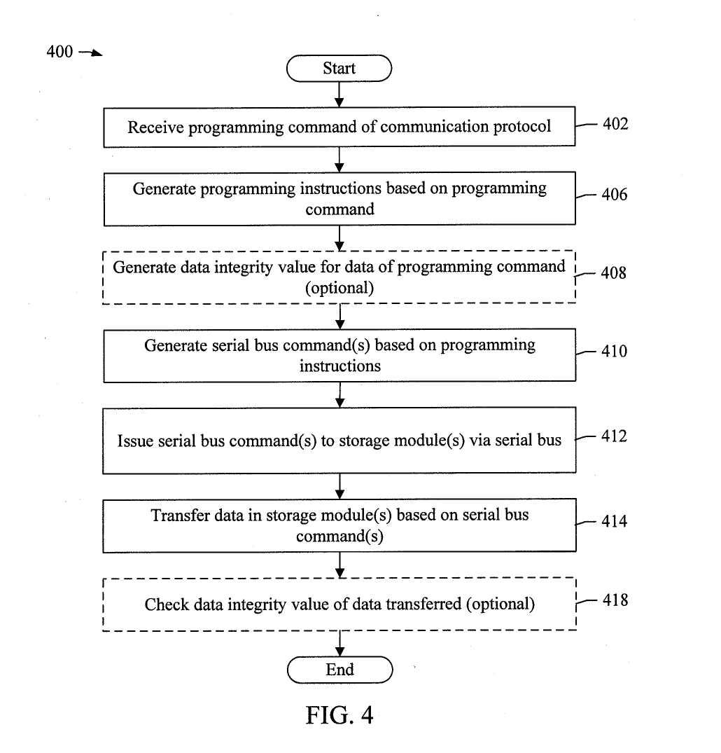

FIG. 4 illustrates a method 400 of accessing data in the flash storage array 110 (FIG. 1), in accordance with an embodiment of the present invention. In step 402, the flash storage controller 105 (FIG. 1) receives a programming command. In one embodiment, the protocol controller 125 (FIG. 1) receives the programming command from the host 120 (FIG. 1). The method 400 then proceeds to step 406.

In step 406, the flash storage controller 105 (FIG. 1) generates programming instructions based on the programming command. In one embodiment, the protocol controller 125 (FIG. 1) generates the programming instructions based on the programming command and provides the programming instructions to the storage processor 135 (FIG. 1) via the computer bus 130 (FIG. 1). The programming instructions may include data of the programming command. The method 400 then proceeds to step 408.

In optional step 408, the flash storage controller 105 (FIG. 1) generates a data integrity value for the data in the programming command. In one embodiment, the storage processor 135 (FIG. 1) generates the data integrity value for the data of the programming command. The method 400 then proceeds to step 410.

In step 410, the flash storage controller 105 (FIG. 1) generates universal serial bus command(s) based on the programming instructions. In one embodiment, the storage processor 135 (FIG. 1) processes the programming instructions to generate the universal serial bus command(s). The method 400 then proceeds to step 412.

In step 412, the flash storage controller 105 (FIG. 1) issues the universal serial bus command(s) to the storage module(s) 115 (FIG. 1) via the universal serial bus(es) 140a or 140b (FIG. 1). In one embodiment, the storage processor 135 (FIG. 1) issues the universal serial bus command(s) to one or more of the storage modules 115 via one or more of the universal serial buses 140a and 140b. The method 400 then proceeds to step 414.

In step 414, each storage module 115 (FIG. 1) that receives a USB command from the flash storage controller 105 (FIG. 1) accesses data in the storage module 115 based on the USB commands. In one embodiment, the USB controller 300 (FIG. 3) of each storage module 115 (FIG. 3) that receives a USB command accesses data in a flash storage unit 305 (FIG. 3) of the storage module 115. The USB controller 300 can access the data in the flash storage unit 305 of the storage module 115 by writing data of the USB command into the flash storage unit 305. Alternatively, the USB controller 300 can access the data in the flash storage unit 305 by reading the data from the flash storage unit 305 and providing the data to the flash storage controller 105 (FIG. 1) via one of the universal serial busses 140a or 140b (FIG. 1). The storage controller 105 can then provide the data to protocol controller 125 (FIG. 1), and the protocol controller 125 provides the data to the host 120 (FIG. 1). The method 400 then proceeds to step 418.

In optional step 418, the flash storage controller 105 (FIG. 1) checks the data integrity value of data received from the storage module(s) 115 (FIG. 1) to determine whether the data is valid. If the data is invalid, the flash storage controller 105 corrects the data based on the data integrity value or provides an error message to the host 120 (FIG. 1).

In one embodiment, the storage processor 135 (FIG. 1) determines whether the data is valid based on the data integrity value of the data. If the data is invalid, the storage processor 135 corrects the data based on the data integrity value or provides an error message to host 120 (FIG. 1) via the protocol controller 125 (FIG. 1). If the data is valid, the storage processor 135 provides the data to the host 120 via the protocol controller 125. The method 400 then ends.

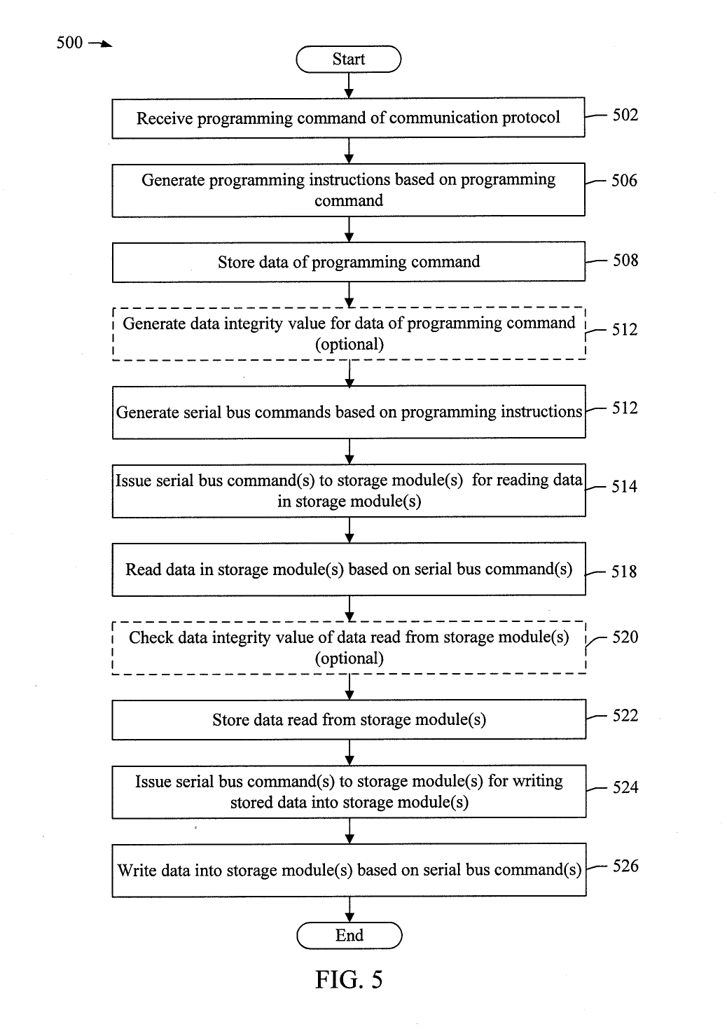

FIG. 5 illustrates a method 500 of accessing data in the flash storage array 110 (FIG. 1), in accordance with another embodiment of the present invention. In step 502, the flash storage controller 105 (FIG. 1) receives a programming command. In one embodiment, the protocol controller 125 (FIG. 1) receives the programming command from the host 120 (FIG. 1). The programming command includes data of a data unit. The method 500 then proceeds to step 506.

In step 506, the flash storage controller 105 (FIG. 1) generates programming instructions based on the programming command. In one embodiment, the protocol controller 125 (FIG. 1) generates the programming instructions based on the programming command and provides the programming instructions to the storage processor 135 (FIG. 1) via the computer bus 130 (FIG. 1). The programming instructions include the data of the programming command. The method 500 then proceeds to step 508.

In step 508, the flash storage controller 105 (FIG. 1) stores the data of the programming command. In one embodiment, the storage processor 135 (FIG. 1) writes the data of the programming command into the data buffer 145 (FIG. 1), and the data buffer 145 stores the data. After step 508, the method 500 proceeds to step 510.

In optional step 510, the flash storage controller 105 (FIG. 1) generates a data integrity value for the data of the programming command. In one embodiment, the storage processor 135 (FIG. 1) generates the data integrity value for the data of the programming command and writes the data integrity value into the data buffer 145 (FIG. 1). In turn, the data buffer 145 stores the data integrity value. The method 500 then proceeds to step 512.

In step 512, the flash storage controller 105 (FIG. 1) generates USB command(s) based on the programming instructions. In one embodiment, the storage processor 135 (FIG. 1) processes the programming instructions to generate the universal serial bus command(s). The method 500 then proceeds to step 514.

In step 514, the flash storage controller 105 (FIG. 1) issues one or more of the USB commands to the storage module(s) 115 (FIG. 1) via the universal serial bus(es) 140a and 140b (FIG. 1). In one embodiment, the storage processor 135 (FIG. 1) issues the universal serial bus command(s) to one or more of the storage modules 115 via one or more of the universal serial buses 140a and 140b. The method 500 then proceeds to step 518.

In step 518, each storage module 115 (FIG. 1) that receives a USB command from the flash storage controller 105 (FIG. 1) reads data in the storage module 115. In one embodiment, the USB controller 300 (FIG. 3) of the storage module 115 reads data of the data unit from a flash storage unit 305 (FIG. 3) in the storage module 115. Additionally, the USB controller 300 provides the data to the flash storage controller 105 (FIG. 1) via one of the universal serial busses 140a or 140b (FIG. 1). The method 500 then proceeds to step 520.

In optional step 520, the flash storage controller 105 (FIG. 1) checks the data integrity value of the data received from the storage module(s) in response to the USB command(s) to determine whether the data is valid. If the data invalid, the flash storage controller 105 provides an error message to the host 120 (FIG. 1) and the method 500 ends. Alternatively, the flash storage controller 105 corrects the data based on the data integrity value and the method proceeds to step 522.

In one embodiment, the storage processor 135 (FIG. 1) checks the data integrity value of the data received from the storage module(s) 115 (FIG. 1) in response to the USB commands(s) to determine whether the data is valid. If the data is invalid, the storage processor 135 corrects the data based on the data integrity value or provides an error message to the host 120 (FIG. 1). If the data is valid or the storage processor 135 corrects the data, the method 500 proceeds to step 522. Otherwise, the method 500 ends.

In step 522, the flash storage controller 105 (FIG. 1) stores the data received from the storage module(s) 115. In one embodiment, the storage processor 125 (FIG. 1) writes the data received from the storage module(s) 115 into the data buffer 145 (FIG. 1), and the data buffer 145 stores the data. The data unit stored in the data buffer 145 includes the data from the programming command as well as the data received from the storage module(s) 115. The method then proceeds to step 524.

In step 524, the flash storage controller 135 (FIG. 1) issues additional USB command(s) to the storage module(s) 115 (FIG. 1) via the universal serial bus(es) 140a and 140b (FIG. 1) for writing the data of the data unit stored in the flash storage controller 135 into the storage module(s) 115. In one embodiment, the storage processor 135 (FIG. 1) issues the additional universal serial bus command(s) to one or more of the storage modules 115 via one or more of the universal serial buses 140a and 140b to write the data stored in the data buffer 145 (FIG. 1) into the storage modules 115. The universal serial bus command(s) issued to the storage module(s) 115 in step 524 are generated in step 512 based on the programming instructions. In an alternative embodiment, the storage processor 135 generates the additional universal serial bus command(s) in step 524 based on the programming instructions before issuing the additional universal serial bus command(s) to the storage module(s) 215. The method 500 then proceeds to step 526.

In step 526, each storage module 115 (FIG. 1) that receives a USB command from the flash storage controller 105 (FIG. 1) stores the data. In one embodiment, the USB controller 300 (FIG. 3) of the storage module 115 writes the data in a flash storage unit 305 (FIG. 3) of the storage module 115. In this way, the data of the data unit is written into the flash storage array 110 (FIG. 1) to replace the previous data unit in the flash storage array 110. The method 500 then ends.

Although the invention has been described with reference to particular embodiments thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A system comprising:
a plurality of universal serial buses;
a plurality of storage modules each coupled to a universal serial bus of the plurality of universal serial buses, each storage module comprising at least one flash storage device; and
a flash storage controller coupled to the plurality of universal serial buses, the flash storage controller configured to receive a programming command of a communication protocol, generate at least one universal serial bus command based on the programming command, and issue the at least one universal serial bus command to at least one storage module of the plurality of storage modules via at least one universal serial bus of the plurality of universal serial buses for accessing data in the at least one flash storage device of the at least one storage module.

2. The system of claim 1, wherein each storage module comprises a plurality of flash storage devices.

3. The system of claim 1, wherein each universal serial bus is a differential bus.

4. The system of claim 1, wherein the communication protocol is a block-based storage area network protocol.

5. The system of claim 1, wherein the flash storage controller comprises:
a protocol controller configured to receive the programming command and generate the programming instructions based on the programming command; and
a processor coupled to the protocol controller and configured to generate the at least one universal serial bus command based on the programming instructions.

6. The system of claim 5, further comprising a data buffer coupled to the processor, the processor further configured to write the data into the data buffer.

7. The system of claim 1, wherein the at least one storage module comprises:
a plurality of flash storage devices comprising the at least one flash storage device; and
a universal serial bus controller coupled to the plurality of universal serial buses, the universal serial bus controller configured to process the at least one universal serial bus command to access the data in the at least one flash storage device of the plurality of flash storage devices.

8. A system of claim 1, wherein the plurality of universal serial buses comprises a first universal serial bus coupled to the flash storage controller and a second universal serial bus coupled to the flash storage controller, the plurality of storage modules comprises a first storage module coupled to the first universal serial bus and a second storage module coupled to the second universal serial bus, and the at least one universal serial bus command comprises a first universal serial bus command and a second universal serial bus command, the flash storage controller further configured to issue the first universal serial bus command to the first storage module via the first universal serial bus for accessing data in the first storage module and to issue the second universal serial bus command to the second storage module for accessing data in the second storage module.

9. The system of claim 8, wherein the first storage module comprises:
a first plurality of flash storage devices comprising the at least one flash storage device of the first storage module; and
a first universal serial bus controller coupled to the first universal serial bus, the first universal serial bus controller configured to process the first universal serial bus command to access the data in the at least one flash storage device of the first plurality of flash storage devices.

10. The system of claim 9, wherein the second storage module comprises:
a second plurality of flash storage devices comprising the at least one flash storage device of the second storage module; and
a second universal serial bus controller coupled to the second universal serial bus, the second universal serial bus controller configured to process the second universal serial bus command to access the data in the at least one flash storage device of the second plurality of flash storage devices.

11. A method comprising:
receiving a programming command of a communication protocol;
generating at least one universal serial bus command based on the programming command; and
issuing the at least one universal serial bus command to at least one storage module via at least one universal serial bus for accessing data in at least one flash storage device of the at least one storage module.

12. The method of claim 11, wherein issuing the at least one universal serial bus command to the at least one storage module via the at least one universal serial bus comprises issuing the at least one universal serial bus command to the at least one storage module via at least one differential universal serial bus.

13. The method of claim 11, wherein receiving the programming command of the communication protocol comprises receiving a programming command of a block-based storage area network protocol.

14. The method of claim 11, further comprising accessing data in the at least one flash storage device of the at least one storage module.

15. The method of claim 11, wherein generating the at least one universal serial bus command based on the programming instructions further comprises generating a first universal serial bus command and a second serial bus command based on the programming instructions, and wherein issuing the at least one universal serial bus command to at least one storage module via at least one universal serial bus comprises issuing the first universal serial bus command to a first storage module comprising at least one flash storage device via a first universal serial bus and issuing the second universal serial bus command to a second storage module comprising at least one flash storage device via a second universal serial bus.

16. The method of claim 15, further comprising:
processing the first universal serial bus command to access data in the at least one flash storage device of the first storage module; and
processing the second universal serial bus command to access data in the at least one flash storage device of the second storage module.

17. A system comprising:
means for receiving a programming command of a communication protocol;
means for generating at least one universal serial bus command based on the programming command; and
means for issuing the at least one universal serial bus command to at least one storage module via at least one universal serial bus for accessing data in at least one flash storage device of the at least one storage module.

18. The system of claim 17, further comprising means for accessing the data in the at least one flash storage module.

19. The system of claim 17, wherein the universal serial bus is a differential bus.

20. The system of claim 17, further comprising:
means for generating programming instructions based on the programming command; and
means for generating the at least one universal serial bus command based on the programming instructions.
